(19) United States
(12) Patent Application Publication
(10) Pub. No.: US 2008/0092897 A1
(43) Pub. Date: Apr. 24, 2008

(54) SEE-THROUGH MASK TO FACILITATE COMMUNICATION IN ENVIRONMENTS REQUIRING THE WEARING OF A MASK

(75) Inventors: Gary W. Behm, Hopewell Junction, NY (US); Robert L. Norton, Wappingers Falls, NY (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/550,509

(22) Filed: Oct. 18, 2006

(51) Int. Cl. A62B 23/02; A62B 18/02

(52) U.S. Cl. 128/206.12; 128/206.21

(57) ABSTRACT

A mask for use by a person working with one or more colleagues who rely upon lip-reading for oral communication. The mask includes a body, including a see-through portion formed of a substantially transparent material, and a retaining member adapted to secure the body to a wearer, wherein with the mask secured to the wearer, the see-through portion of the body is positioned over the lips of the wearer.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

In environments where facemasks are generally worn to protect either a wearer or the environment itself, such as for example a “clean room”, medical office, surgical room, etc., communication is impeded because the mouth of the wearer is obscured. Since such masks are commonly thin, it is not the acoustic component of speech that is restricted but rather it is the optical component, affecting perception of both the movements of the mouth itself and a substantial amount of the facial expression. More specifically, it will be appreciated that people tend to watch the mouth of the speaker and facial expression whenever conditions of hearing the spoken words are less than optimal. This is especially true for people who are for one reason or another hearing impaired. It always has been an issue in the “clean room” where deaf or hard of hearing employees and hearing employees are trying to communicate. One of the resulting conditions occurring in response to this problem is that wearers will lower the mask to effect communication. This is in some cases a violation of protocol and in some cases could have more dire consequences such as causing infection of a patient or destruction of a sensitive component, with inherent financial consequences. It would therefore be beneficial to the art to provide a mask that achieves the goals that originally dictate the wearing of the mask while avoiding the above-identified drawbacks.

### SUMMARY OF THE INVENTION

A see-through mask includes a mask body having at least a see-through portion consisting of a see-through material facilitating visual perception of a mouth of a wearer by another and a retaining member secured to the see-through portion and supportive of the see-through portion on the wearer.

A mask for use by a person working with one or more colleagues who rely upon lip-reading for oral communication. The mask includes a body, including a see-through portion formed of a substantially transparent material, and a retaining member adapted to secure the body to a wearer, wherein with the mask secured to the wearer, the see-through portion of the body is positioned over the lips of the wearer.

### BRIEF DESCRIPTION OF THE DRAWINGS

The invention will be best understood by reference to the following detailed description of an illustrative embodiment when read in conjunction with the accompanying drawings, wherein:

FIG. 1 is an illustration of a mask having a substantially transparent window therein located to register with a wearer's mouth when worn as shown;

FIG. 2 is an illustration of an alternative mask having a larger window.

### DETAILED DESCRIPTION OF THE INVENTION

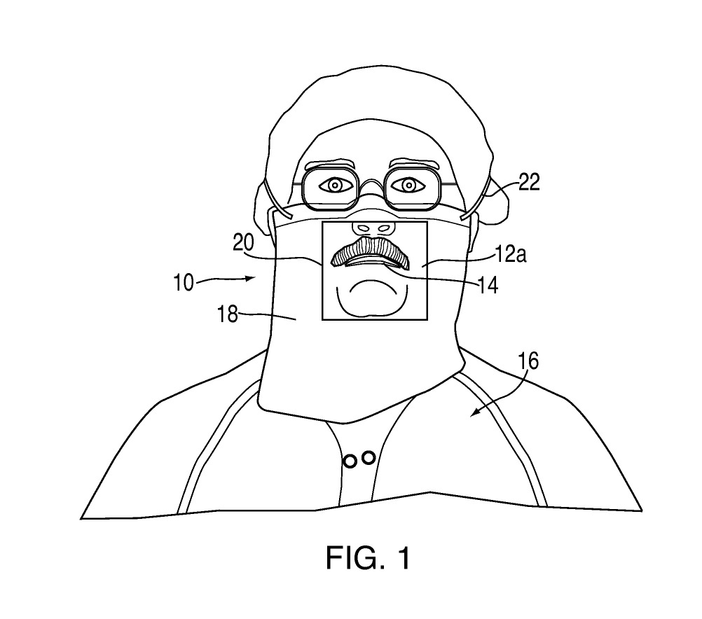

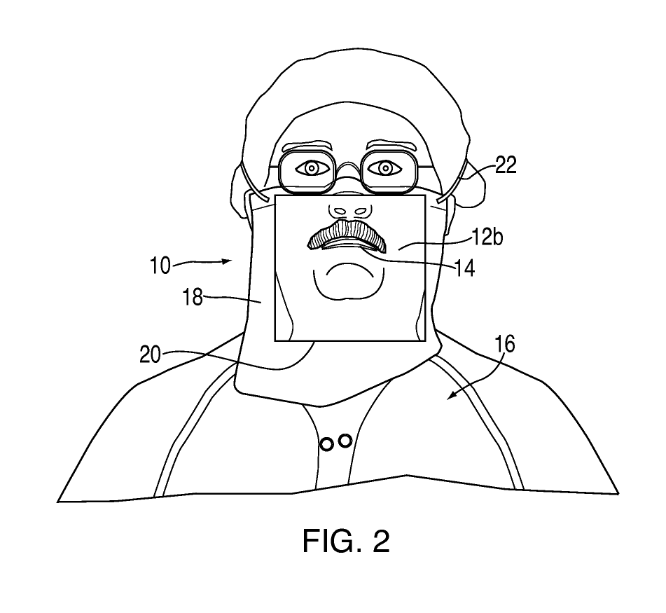

Referring to FIGS. 1 and 2 simultaneously, it will be appreciated that a Mask body 10 as disclosed herein may comprise anywhere from a relatively small see-through window 12 (see-through portion), large enough only to see mouth 14 movement of the wearer all the way to the entire mask being constructed of see-through material. A smaller window 12a is illustrated in FIG. 1 while a larger window 12b is illustrated in FIG. 2. In order to achieve the goals hereof, both gas permeability in sufficient volume to support normal human breathing and visibility through the mask must be achieved. In one embodiment, an apertured polyethylene film (APEF), which is a see-through material, is utilized for a part of or the entire mask. This material is permeable to air at a sufficient rate for breathing and provides good see-through conditions. The material is at least near transparent. The aperture size of the material is small enough to exclude matter that must be controlled in the environments noted or similar, yet allow for gas passage associated with respiration. In one embodiment the hole size is up to 75 microns in diameter. APEF is commercially available from a variety of sources.

Alternatively, the material utilized may be a low-density polyethylene film (LDPE), which may be engineered to be translucent or even to be optically clear. This material, however, is not permeable to gas in sufficient volume to support normal human respiration and therefore to be used must make up a smaller portion of the mask. This material would be utilized in embodiments that provide only a view to the immediate vicinity of the mouth 14 of the wearer 16. While facial expression is not visible in such embodiment, like that in FIG. 2, lip reading is facilitated.

Regardless of the material choice for the see-through portion of the mask (for all embodiments where the see-through portion does not make up all of the mask), the see-through portion must be attached to a carrier portion 18, which likely but not necessarily (in the case APEF makes up enough of the mask to support human respiration itself), will be permeable to gas, facilitating human respiration. This material may be any standard mask material known to the industry. Attachment may be effected by bonding or by mechanical securement at an interface 20 between the window 12 and carrier portion 18. Bonding methods will be familiar to those of skill in the art of mask making and include but are not limited to welding, gluing, etc. and mechanical securement may be accomplished by such arrangements as sewing, etc.

In order to mount the body 10 of the mask on a wearer 16, a retaining member 22 is provided that attaches to the carrier portion or directly to the see-through portion. The retaining member may be an elastic band familiar to those of skill in the art and may be attached to the body 10 of the mask by bonding or mechanically in known ways.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A see-through mask comprising:
a mask body having at least a see-through portion consisting of a see-through material facilitating visual perception of a mouth of a wearer by another;
a retaining member secured to the see-through portion and supportive of the see-through portion on the wearer.

2. The see-through mask as claimed in claim 1, wherein the body further includes a carrier portion supportive of the see-through portion.

3. The see-through mask as claimed in claim 2, wherein the carrier portion is gas permeable in sufficient volume to support human respiration.

4. The see-through mask as claimed in claim 1, wherein the see-through portion is an apertured polyethylene film.

5. The see-through mask as claimed in claim 1 wherein the see-through portion is a low-density polyethylene film.

6. The see-through mask as claimed in claim 1 wherein the see-through portion is all of the body of the mask.

7. The see-through mask as claimed in claim 1 wherein the retaining member is an elastic band.

8. A mask for use by a person working with one or more colleagues who rely upon lip-reading for oral communication, comprising:
a body, including a see-through portion formed of a substantially transparent material;
a retaining member adapted to secure the body to a wearer, wherein with the mask secured to the wearer, the see-through portion of the body is positioned over the lips of the wearer.
